(19) United States
(12) Patent Application Publication
(10) Pub. No.: US 2013/0245176 A1
(43) Pub. Date: Sep. 19, 2013

(54) POLYMER THICK FILM FERRITE-CONTAINING SHIELDING COMPOSITION

(71) Applicant: E I DU PONT DE NEMOURS AND COMPANY, Wilmington, DE (US)

(72) Inventors: JAY ROBERT DORFMAN, Durham, NC (US); John Graeme Pepin, Raleigh, NC (US)

(73) Assignee: E I DU PONT DE NEMOURS AND COMPANY, Wilmington, DE (US)

(21) Appl. No.: 13/773,709

(22) Filed: Feb. 22, 2013

Related U.S. Application Data
(60) Provisional application No. 61/612,527, filed on Mar. 19, 2012.

(51) Int. Cl. H01B 3/42; H01B 3/44

(52) U.S. Cl. CPC H01B 3/427; H01B 3/447
USPC 524/317

(57) ABSTRACT

This invention relates to a polymer thick film shielding composition comprising “soft” ferrite powder and an organic medium comprising a thermoplastic resin dissolved in an organic solvent.

### FIELD OF THE INVENTION

This invention is directed to a polymer thick film shielding composition. More specifically, the polymer thick film (PTF) shielding composition may be used in applications where a radio frequency identification (RFID) circuit needs to be shielded from other metal surfaces. The composition may be screen-printed onto polyester or other substrates and dried.

### BACKGROUND OF THE INVENTION

PTF shielding circuits have long been used as electrical elements. Although they have been used for years in many different types of applications, the use of PTF “soft” ferrite-containing materials in shielding applications is not common. This is particularly important in circuits where an RHO chip is to be shielded from a metal surface.

### SUMMARY OF THE INVENTION

This invention relates to a polymer thick film shielding composition comprising:
(a) 40-95 wt % soft ferrite powder; dispersed in
(b) 5-60 wt % organic medium comprising 10-50 wt % thermoplastic resin dissolved in 50-90 wt % organic solvent;
   wherein the wt % of the soft ferrite powder and the organic medium are based on the total weight of the shielding composition and wherein the weight percent of the thermoplastic resin and the organic solvent are based on the total weight of said organic medium.

The invention is further directed to using the PTF shielding composition to form shielding circuits to shield conductive electrical circuits from metal surfaces and, in particular, to shield RFID chips from metal surfaces.

### DETAILED DESCRIPTION OF THE INVENTION

The invention relates to a polymer thick film ferrite-containing shielding composition for use in electrical circuits and, in particular, RFID circuitry. A layer of the PTF shielding composition is screen-printed and dried on a substrate so as to produce a functioning circuit shielding element.

The polymer thick film shielding composition is comprised of (i) a “soft” ferrite powder, dispersed in (ii) an organic medium comprising a polymer resin dissolved in organic solvent. Additionally, other powders and printing aids may be added to improve the composition.

### A. “Soft” Ferrite Powder

Ferrites are chemical compounds consisting of ceramic materials with iron(III) oxide (Fe₂O₃) as their principal component. Many of them are magnetic materials and they are used to make permanent magnets, ferrite cores for transformers, and in various other applications. Ferrites are usually non-conductive ferrimagnetic ceramic compounds derived from iron oxides such as hematite (Fe₂O₃) or magnetite (Fe₃O₄) as well as oxides of other metals. Ferrites are, like most other ceramics, hard and brittle. In terms of their magnetic properties, the different ferrites are often classified as “soft” or “hard”, which refers to their low or high magnetic coercivity. Ferrites that are used in transformer or electromagnetic cores contain zinc, nickel, and/or manganese. They have a low coercivity and are called soft ferrites and it is in this sense that the ferrites used herein are called soft ferrites. The low coercivity means the material's magnetization can easily reverse direction without dissipating much energy (hysteresis losses), while the material's high resistivity prevents eddy currents in the core, another source of energy loss. Because of their comparatively low losses at high frequencies, they are extensively used in the cores of RF transformers and inductors in applications such as switched-mode power supplies.

In an embodiment, the soft ferrite powder in the present thick film composition is doped iron oxide powder. Various particle diameters and shapes of the metal powder are contemplated. In an embodiment, the soft ferrite powder may include any shape powder, including spherical particles, flakes (rods, cones, plates), and mixtures thereof. In an embodiment, the ferrite powder may include irregularly-shaped particles.

In an embodiment, the particle size distribution of the soft ferrite powder is from 1 to 100 μm. In a further embodiment, the particle size distribution of the soft ferrite powders is 5 to 5-0 μm.

In an embodiment, the surface area/weight ratio of he ferrite particles is in the range of 0.1-2.0 m²/g.

### B. Organic Medium

The organic medium is comprised of a thermoplastic resin dissolved in an organic solvent. The resin must achieve good adhesion to the underlying substrate. It must be compatible with and not adversely affect the performance of the circuit after deposition and drying.

In one embodiment the thermoplastic resin is 10-50 wt % of the total weight of the organic medium and the solvent is 50-90 wt % of the total weight of the organic medium. In another embodiment the thermoplastic resin is 15-45 wt % of the total weight of the organic medium and the solvent is 55-85 wt % of the total weight of the organic medium. In still another embodiment the thermoplastic resin is 20-30 wt % of the total weight of the organic medium and the solvent is 70-80 wt % of the total weight of the organic medium. In one embodiment the thermoplastic resin is a phenoxy polymer, In another embodiment the thermoplastic resin is a vinylidene chloride/acrylonitrile-based copolymer.

The polymer resin is typically added to the organic solvent by mechanical mixing to form the medium. Solvents suitable for use in the polymer thick film composition are recognized by one skilled in the art and include acetates and terpenes such as carbitol acetate and alpha- or beta-terpineol or mixtures thereof with other solvents such as kerosene, dibutylphthalate, butyl carbitol, butyl carbitol acetate, hexylene glycol and high boiling alcohols and alcohol esters. In addition, volatile liquids for promoting rapid hardening after application on the substrate may be included. In many embodiments of the present invention, solvents such as glycol ethers, ketones, esters and other solvents of like boiling points (in the range of 180° C. to 250° C.), and mixtures thereof may be used. Various combinations of these and other solvents are formulated to obtain the viscosity and volatility requirements desired. The solvents used must solubilize the resin.

### Additional Powders

Various powders may be added to the PTF composition to improve adhesion, modify the rheology and increase the low shear viscosity thereby improving the printability.

### Application Of The PTF Shielding Composition

In an embodiment, the PTF shielding composition comprises 40 to 95 wt % soft ferrite powder and 5 to 60 wt % organic medium, based on the total weight of the shielding composition. In another embodiment, the PTF shielding composition comprises 70 to 92 wt % soft ferrite powder and 8-30 wt % organic medium, based on the total weight of the shielding composition. In still another embodiment, the PTF shielding composition comprises 80 to 90 wt % soft ferrite powder and 10 to 20 wt % organic medium, based on the total weight of the shielding composition.

The PTF shielding composition, also referred to as a “paste”, is typically deposited on a substrate, such as polyester, that is impermeable to gases and moisture. The substrate can also be a sheet of a composite material made up of a combination of plastic sheet with optional metallic or dielectric layers deposited thereupon.

The deposition of the PTF shielding composition is performed typically by screen printing, but other deposition techniques such as stencil printing, syringe dispensing or coating techniques can be utilized. In the case of screen-printing, the screen mesh size controls the thickness of the deposited thick film.

Generally, a thick film composition comprises a functional phase that imparts appropriate electrically functional properties to the composition. The functional phase comprises electrically functional powders dispersed in an organic medium that acts as a carrier for the functional phase. Generally, the composition is fired to burn out both the polymer and the solvent of the organic medium and to impart the electrically functional properties. However, in the case of a polymer thick film, the polymer portion of the organic medium remains as an integral part of the composition after drying.

The PTF shielding composition is processed for a time and at a temperature necessary to remove all solvent. For example, the deposited thick film is dried by exposure to heat at 140° C. for typically 10-15 min.

### Shielding Circuit Construction

The base substrate used is typically 5 mil thick polyester. The shielding composition is printed and dried as per the conditions described above.

### EXAMPLE

The PTF shielding composition was prepared in the following manner. The organic medium was prepared by mixing 25.0 wt % InChemRez™ Phenoxy resin PKHH (Phenoxy Associates, Rock Hill, S.C.) with 60.0 wt % carbitol acetate (obtained from Eastman Chemicals Co., Kingsport, Tenn.) organic solvent and 15.0 wt. % Dowanol™ DPM glycol ether (The Dow Chemical Company, Midland, Mich.) organic solvent. The molecular weight of the resin was approximately 20,000. This mixture was heated at 90° C. for 1-2 hours to dissolve all the resin. The wt % of the resin and solvents were based on the total weight of the organic medium.

85.0 wt % of soft ferrite powder FA-100, −325 mesh (PPT, Valparaiso, Ind.) with an average particle size of approximately 30 μm was added to 15.0 wt % of the organic medium, wherein the wt % of the soft ferrite powder and the organic medium were based upon the total weight of the shielding composition.

This composition was mixed for 30 minutes on a planetary mixer.

A shielding circuit was then fabricated as follows. On a 5 mil thick polyester substrate, a pattern of a series of serpentine lines was printed using a 200 mesh stainless steel screen. The patterned lines were dried at 130° C. for 10 min. in a forced air box oven. The part was inspected and minimal crazing or deformation of the underlying substrate was found. After drying at 130° C., the shielding circuit lines were well adhered to the substrate.

What is claimed is:

1. A polymer thick film shielding composition comprising:
(a) 40-95 wt % soft ferrite powder; dispersed in
(b) 5-60 wt % organic medium comprising 10-50 wt % thermoplastic resin dissolved in 50-90 wt % organic solvent;
wherein the wt % of the soft ferrite powder and the organic medium are based on the total weight of the shielding composition and wherein the wt % of the thermoplastic resin and the organic solvent are based on the total weight of said organic medium.

2. The polymer thick film shielding composition of claim 1, wherein said thermoplastic resin is a phenoxy polymer.

3. The polymer thick film shielding composition of claim 1, wherein said thermoplastic resin is a vinylidene chloride/acrylonitrile copolymer.

4. The polymer thick film shielding composition of claim 1, said shielding composition comprising:
(a) 70-92 wt % soft ferrite powder; dispersed in
(b) 8-30 wt % organic medium comprising 15-45 wt % thermoplastic resin dissolved in 55-85 wt % organic solvent.

5. The polymer thick film shielding composition of claim 4, said shielding composition comprising:
(a) 80-90 wt % soft ferrite powder; dispersed in
(b) 10-20 wt % organic medium comprising 20-30 wt % thermoplastic resin dissolved in 70-80 wt % organic solvent.

6. A shielding circuit formed from a polymer thick film shielding composition, said polymer thick film shielding composition comprising:
(a) 40-95 wt % soft ferrite powder; dispersed in
(b) 5-60 wt % organic medium comprising 10-50 wt % thermoplastic resin dissolved in 50-90 wt % organic solvent;
wherein the wt % of the soft ferrite powder and the organic medium are based on the total weight of the shielding composition and wherein the wt % of the thermoplastic resin and the organic solvent are based on the total weight of said organic medium.

7. The shielding circuit of claim 6, wherein said thermoplastic resin is a phenoxy polymer.

8. The shielding circuit of claim 6, wherein said thermoplastic resin is a vinylidene chloride/acrylonitrile copolymer.

9. The shielding circuit of claim 6, said shielding composition comprising:
(a) 70-92 wt % soft ferrite powder; dispersed in
(b) 8-30 wt % organic medium comprising 15-45 wt % thermoplastic resin dissolved in 55-85 wt % organic solvent

10. The shielding circuit of claim 9, said shielding composition comprising:
(a) 80-90 wt % soft ferrite powder; dispersed in
(b) 10-20 wt % organic medium comprising 20-30 wt % thermoplastic resin dissolved in 70-80 wt % organic solvent.
